(19) United States
(12) Patent Application Publication
(10) Pub. No.: US 2016/0210625 A1
(43) Pub. Date: Jul. 21, 2016

(54) TERMINAL DEVICE, SERVER DEVICE, METHOD, AND PROGRAM RECORDING MEDIUM FOR VALIDITY CONTROL

(71) Applicant: NEC CORPORATION, Tokyo (JP)

(72) Inventors: Saburo Shiota, Tokyo (JP); Yuichi Koike, Tokyo (JP)

(21) Appl. No.: 14/914,757

(22) PCT Filed: Aug. 21, 2014
(86) PCT No.: PCT/JP2014/004282

§ 371 Date: Feb. 26, 2016

(30) Foreign Application Priority Data
Sep. 13, 2013 (JP) 2013-190156

(51) Int. Cl. G06Q 20/40

(52) U.S. Cl. CPC G06Q 20/40

(57) ABSTRACT

A terminal device for making it easy to reuse an IC card 3 on which validity information indicating invalid has been written by being once invalidated is provided. The terminal device includes a list storage means and a recording means. The list storage means stores a whitelist associating an invalid count identifying value of a recording medium that stores an identifier, validity information indicating valid or invalid, and a setting value with the identifier. The recording means reads out, from the whitelist, the invalid count identifying value corresponding to the identifier read out from the recording medium, compares the invalid count identifying value with the setting value read out from the recording medium, and executes a validation process that stores the validity information indicating valid on the recording medium and a predetermined process when the setting value is equal to the invalid count identifying value.

### TECHNICAL FIELD

The present invention relates to a terminal device, a server device, a method, and a program recording medium for validity control, and in particular, to a terminal device, a server device, a method, and a program recording medium for controlling valid/invalid of a credit card and the like using a whitelist.

### BACKGROUND ART

PTL 1 discloses a system that executes processing of a use stop for a credit card illegally used to buy a product or a service. Herein, the processing of a use stop refers to processing for destroying a part of information written on a card, processing for writing wrong information on a card, or processing for setting a flag indicating unusable (invalid) for a card.

Initially, a host computer of the system outputs information including a blacklist of credit cards of credit company members as card information. The blacklist is a list of invalid cards. A terminal computer of a member store receives and stores the information, and executes processing of a card use stop when a credit card input to a card reader is listed on the blacklist.

In the system, the host computer transmits information of all the card members regularly or irregularly. When the member store holds basic card information, only information at the time when a credit card is changed to be invalid from being valid or to be valid from being invalid is transmitted, and thereby the basic information is updated at the member store.

### CITATION LIST

### Patent Literature

[PTL 1] Japanese Laid-open Patent Publication No. H11-143949

### SUMMARY OF INVENTION

### Technical Problem

It is difficult that a credit card subjected to processing of a use stop by the system described in PTL 1 is easily reused. The reason is that a part of information written on the credit card is destroyed or a flag indicating invalid is set for the card.

However, there is a case in which a credit card once subjected to processing of a use stop is intended to be reused. This is a case in which, for example, a user having once failed in payment due to a balance shortage in a bank account and having been subjected to a use stop of a credit card hopes to continue to use the credit card after settlement of an outstanding balance. In such a case, in the system described in PTL 1, for the user, a new credit card needs to be issued from a credit company. Alternatively, it is necessary for the user to bring the credit card to a store of the company and request the store to restore destroyed information or delete a flag indicating invalid. This is inconvenient for the user.

A similar situation occurs with respect to an IC (Integrated Circuit) card storing electronic money and the like. An object of the present invention is to provide a technique for solving the problem and reducing a user burden for reusing a card once subjected to a use stop.

### Solution to Problem

A terminal device according to an exemplary aspect of the invention includes: a list storage means for storing a whitelist associating an invalid count identifying value of a recording medium that stores an identifier, validity information indicating valid or invalid, and a setting value with the identifier; and a recording means for reading out, from the whitelist, the invalid count identifying value corresponding to the identifier read out from the recording medium, comparing the invalid count identifying value with the setting value read out from the recording medium, and executing a validation process that stores the validity information indicating valid on the recording medium and a predetermined process when the setting value is equal to the invalid count identifying value.

A server device according to an exemplary aspect of the invention includes: when the server device is connected to a terminal device that reads out, from a whitelist stored in the terminal device, an invalid count identifying value corresponding to an identifier read out from a recording medium, compares the invalid count identifying value with a setting value read out from the recording medium, and executes a validation process that stores the validity information indicating valid on the recording medium and a predetermined process when the setting value is equal to the invalid count identifying value, an invalid count storage means for storing the invalid count identifying value in association with the identifier of the recording medium invalidated; a list master storage means for storing an original of the whitelist and an original of a blacklist associating the invalid count identifying value of the recording medium with the identifier; an adding means for advancing, when the identifier of the recording medium invalidated is input, the invalid count identifying value stored on the invalid count storage means in association with the input identifier, adding the advanced value to the original of the blacklist as the invalid count identifying value corresponding to the input identifier, and adding, when the identifier of the recording medium returned to be valid is input, the invalid count identifying value corresponding to the input identifier to the original of the whitelist; and a list distributing means for distributing the original of the whitelist to the terminal device.

A method according to an exemplary aspect of the invention includes: storing a whitelist associating an invalid count identifying value of a recording medium that stores an identifier, validity information indicating valid or invalid, and a setting value with the identifier; and reading out, from the whitelist, the invalid count identifying value corresponding to the identifier read out from the recording medium, comparing the invalid count identifying value with the setting value read out from the recording medium, and executing a validation process that stores the validity information indicating valid on the recording medium and a predetermined process when the setting value is equal to the invalid count identifying value.

A method according to an exemplary aspect of the invention includes: connecting to a terminal device that reads out, from a whitelist stored in the terminal device, an invalid count identifying value corresponding to an identifier read out from a recording medium, compares the invalid count identifying value with a setting value read out from the recording medium, and executes a validation process that stores the validity information indicating valid on the recording medium and a predetermined process when the setting value is equal to the invalid count identifying value; storing the invalid count identifying value in association with the identifier of the recording medium invalidated, in an invalid count storage means; storing an original of the whitelist and an original of a blacklist associating the invalid count identifying value of the recording medium with the identifier; advancing, when the identifier of the recording medium invalidated is input, the invalid count identifying value stored on the invalid count storage means in association with the input identifier, adding the advanced value to the original of the blacklist as the invalid count identifying value corresponding to the input identifier, and adding, when the identifier of the recording medium returned to be valid is input, the invalid count identifying value corresponding to the input identifier to the original of the whitelist; and distributing the original of the whitelist to the terminal device.

### Advantageous Effects of Invention

A system according to the present invention is a credit card, an IC card storing electronic money, or the like and can reduce a user burden applied to reuse a card once subjected to a use stop.

### BRIEF DESCRIPTION OF DRAWINGS

FIG. 1 is a configuration diagram of a validity control system 4 according to a first exemplary embodiment.

FIG. 2A illustrates a configuration of a blacklist 61 stored on a list storage 12 of a terminal device 1 and a list master storage 22 of a server device 2.

FIG. 2B illustrates a configuration of a whitelist 64 stored on the list storage 12 of the terminal device 1 and the list master storage 22 of the server device 2.

FIG. 3 illustrates cumulative data of logs stored on a log storage 21 of the server device 2.

FIG. 4 is an operation flowchart (No. 1) of a recorder 11 of the terminal device 1.

FIG. 5 is an operation flowchart (No. 2) of the recorder 11 of the terminal device 1.

FIG. 6 is an operation flowchart of a processor 13 of the terminal device 1.

FIG. 7 is an operation flowchart (No. 1) of an adding module 23 of the server device 2.

FIG. 8 is an operation flowchart (No. 2) of the adding module 23 of the server device 2.

FIG. 9 is a configuration diagram of a validity control system 4 according to a second exemplary embodiment.

FIG. 10 illustrates a configuration of data stored on a card master storage 28 of the server device 2.

FIG. 11 is an operation flowchart of the adding module 23 of the server device 2 according to the second exemplary embodiment.

FIG. 12 is a configuration diagram of a terminal device 1 according to a third exemplary embodiment.

FIG. 13 is a configuration diagram of a server device 2 according to a fourth exemplary embodiment.

### DESCRIPTION OF EMBODIMENTS

### First Exemplary Embodiment

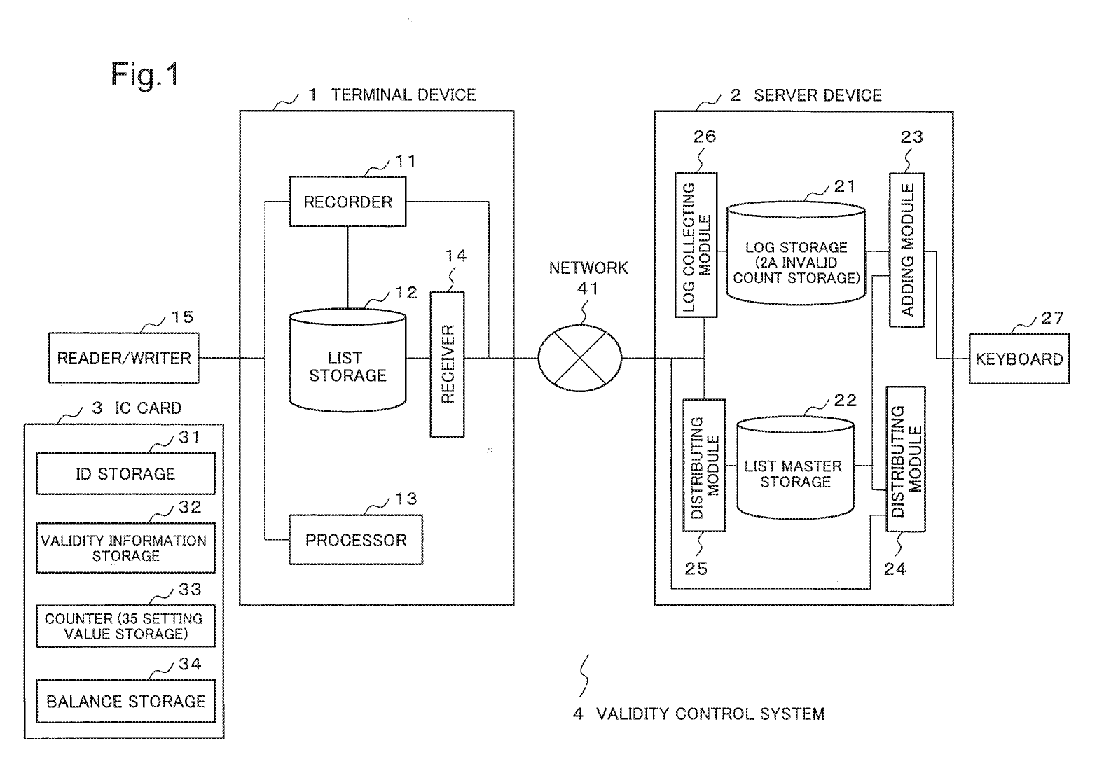

FIG. 1 is a configuration diagram of a validity control system 4 according to an exemplary embodiment. The validity control system 4 includes a terminal device 1 and a server device 2 connected via a network 41. There are commonly a plurality of terminal devices 1. The terminal device 1 is set at, for example, a payment counter of a dealer. The server device 2 is set in, for example, a bank or a credit card company.

The terminal device 1 includes a recorder 11, a list storage 12, a processor 13, and a receiver 14. The recorder 11 and the processor 13 are connected with a reader/writer 15.

The reader/writer 15 reads and writes data stored on an IC card 3. The IC card 3 is, for example, a portable recording medium that stores electronic money. Alternatively, the IC card 3 may be a credit card. A holder of the IC card 3 pays a purchase price for a product or a service with the IC card 3 at a dealer.

The IC card 3 includes an ID storage 31 that stores a card ID or a user ID (IDentification, hereinafter, referred to simply as an ID), a validity information storage 32 that stores validity information indicating that the IC card 3 is valid or invalid, and a counter 33 that stores a count in which the IC card 3 has been invalidated. An initial value of the validity information storage 32 is “valid,” and an initial value of the counter 33 is 0. The IC card 3 may further include a balance storage 34 that stores a balance of electronic money stored thereon or a credit balance of a credit card.

A holder of an IC card 3 can pay with the IC card 3 only when validity information stored on the validity information storage 32 indicates valid. The holder can pay, for example, an amount of money stored on the balance storage 34.

When, for example, a legitimate holder loses an IC card 3 and then applies for a use stop of the IC card 3 to a bank or a credit card company, the IC card 3 becomes invalid. When, for example, the legitimate holder finds the IC card 3 at home and then applies for a release of the use stop to the bank or the credit card company, the IC card 3 is returned to be valid. Further, in the case of being a credit card, the IC card 3 becomes invalid by an operation of a credit card company when, for example, it is impossible to withdraw a billed amount from a bank account, and thereafter the IC card 3 is returned to be valid by an operation of the credit card company when money is deposited in the bank account and it becomes possible to perform a withdrawal.

Validity information indicating invalid is stored on the validity information storage 32 of an IC card 3 being invalid when the IC card 3 is tapped to the reader/writer 15 of the terminal device 11. Therefore, a time difference is generated between an invalid state of the IC card 3 and storage of validity information indicating invalid. In the same manner, a time difference is generated between a return to a valid state of the IC card 3 and storage of validity information indicating valid.

The list storage 12 of the terminal device 1 stores a blacklist 61 indicating an ID and the like of an invalidated IC card 3 and a whitelist 64 indicating an ID and the like of an IC card 3 returned to be valid from being invalid. When an ID read out from an IC card 3 has been registered on the blacklist 61 stored on the list storage 12, the recorder 11 records invalid on the validity information storage 32 of the IC card 3. At that time, the recorder 11 creates a log and transmits the created log to the server device 2. When the ID read out from the IC card 3 has been registered on the whitelist 64 stored on the list storage 12, the recorder 11 records valid on the validity information storage 32 of the IC card 3. The processor 13 executes a predetermined process, for example, a payment process when validity information read out from the IC card 3 indicates valid.

The receiver 14 receives, for example, the blacklist 61 and the whitelist 64 from the server device 2 and stores the lists on the list storage 12. The server device 2 creates and updates originals of the blacklist 61 and the whitelist 64, and distributes the updated originals to the terminal device 1 via the network 41. The receiver 14 of the terminal device 1 receives the updated originals, stores the originals on the list storage 12, and thereby stores duplicates of the blacklist 61 and the whitelist 64. The distribution of the blacklist 61 or the whitelist 64 may be performed through mailing of an interchangeable medium or the like instead of communication.

The recorder 11, the processor 13, and the receiver 14 each include a logic circuit or the like. It is possible that they are implemented using software stored on a memory (not illustrated) of the terminal device 1 executed by a processor (not illustrated) of the terminal device 1. The list storage 12 is a storage device such as an IC memory, a disk device, or the like.

The server device 2 includes a log storage 21, a list master storage 22, an adding module 23, a deleting module 24, a distributing module 25, and a log collecting module 26. The adding module 23 is connected with a keyboard 27.

When acquiring an ID of an IC card 3 to be invalidated from the keyboard 27, the adding module 23 adds the ID and the like to the original of the blacklist 61, and when acquiring an ID of an IC card 3 to be returned to be valid from the keyboard 27, the adding module 23 adds the ID and the like to the original of the whitelist 64. When receiving “a request for deletion from the blacklist” identifying an ID of an IC card 3 from the recorder 11 of the terminal device 1, the deleting module 24 deletes the ID and the like from the original of the blacklist 61. In the same manner, when receiving “a request for deletion from the whitelist” identifying an ID of an IC card 3 from the recorder 11 of the terminal device 1, the deleting module 24 deletes the ID and the like from the original of the whitelist 64.

The list master storage 22 stores the originals of the blacklist 61 and the whitelist 64. The distributing module 25 distributes duplicates of the blacklist 61 and the whitelist 64 stored on the list master storage 22 to the terminal device 1.

The log collecting module 26 receives the log described above from the recorder 11 of the terminal device 1 and stores the log on the log storage 21, for example, in chronological order. The log storage 21 is referred to by the adding module 23.

The adding module 23, the deleting module 24, the distributing module 25, and the log collecting module 26 each include a logic circuit or the like. It is possible that they are implemented using software stored on a memory (not illustrated) of the server device 2 and executed by a processor (not illustrated) of the server device 2. The log storage 21 and the list master storage 22 each are a storage device such as an IC memory, a disk device, or the like.

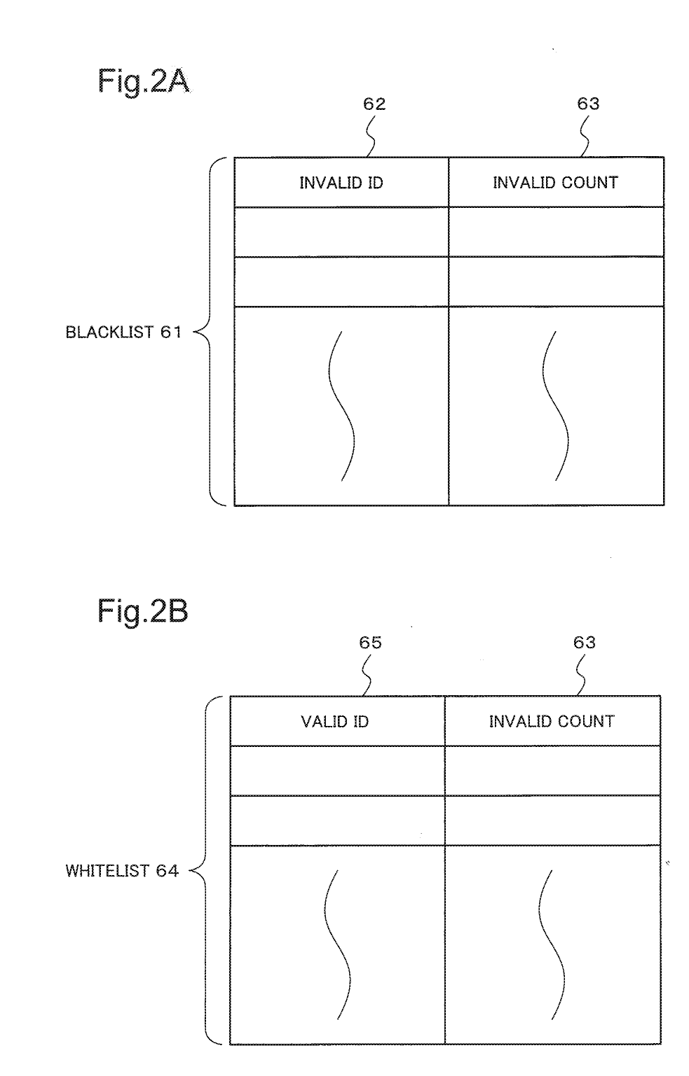

FIG. 2A illustrates a configuration of the blacklist 61 stored on the list storage 12 of the terminal device 1 and the list master storage 22 of the server device 2. The blacklist 61 is a list of a pair of an invalid ID 62 that is an ID of an invalidated IC card 3 and an invalid count 63 that is a count of invalidation thereof.

FIG. 2B illustrates a configuration of the whitelist 64 stored on the list storage 12 of the terminal device 1 and the list master storage 22 of the server device 2. The whitelist 64 is a list of a pair of a valid ID 65 that is an ID of an IC card 3 returned to be valid from being invalid and an invalid count 63 that is a count of invalidation thereof.

It is not always necessary for the blacklist 61 and the whitelist 64 to be separate lists. It is possible that a record included in the blacklist 61 and a record included in the whitelist 64 are mixed in a single list and discrimination information is provided in the records.

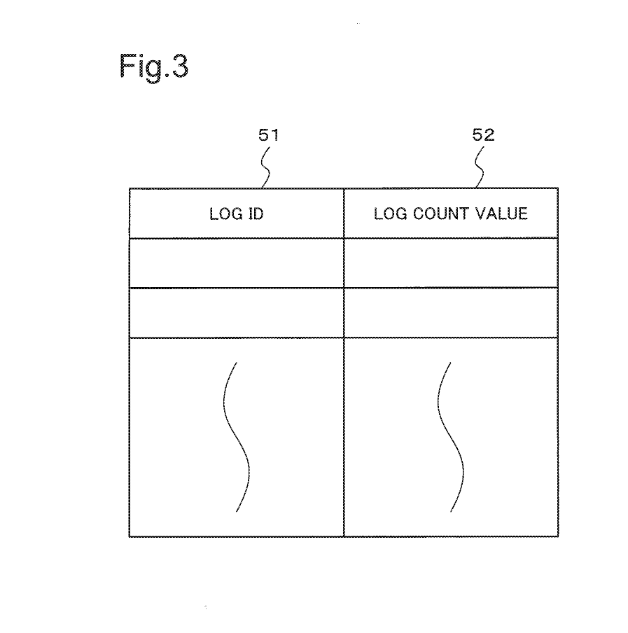

FIG. 3 illustrates cumulative data of logs stored on the log storage 21 of the server device 2. The recorder 11 of the terminal device 1 transmits a log including an ID read out from an IC card 3 and an updated value (a value written on the IC card 3) of a count value to the server device 2. The log collecting module 26 stores the ID of the received log and the updated value of the count value on a log ID 51 and a log count value 52 of the log storage 21, respectively.

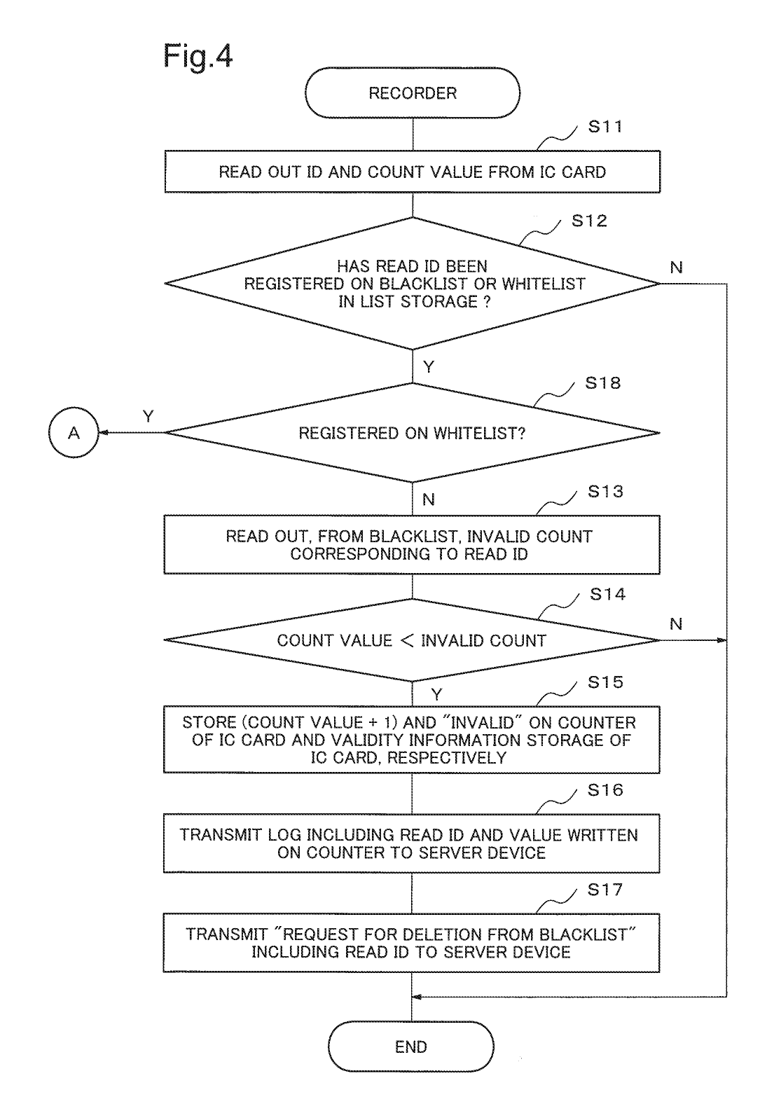

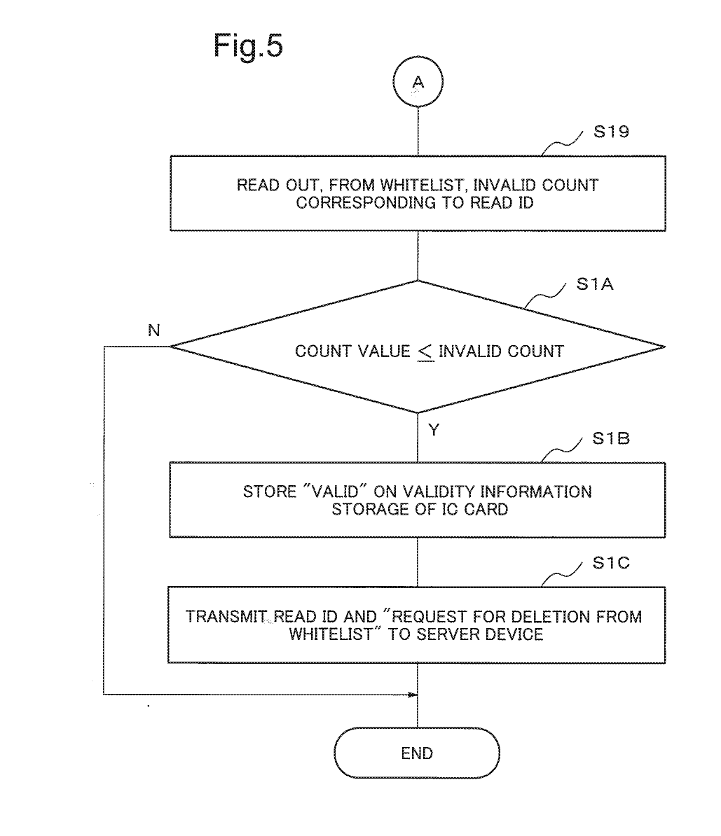

FIG. 4 and FIG. 5 each are an operation flowchart of the recorder 11 of the terminal device 1. The recorder 11 is started when, for example, an IC card 3 is tapped to the reader/writer 15.

The recorder 11 reads out an ID and a count value from an IC card 3 (S11). The ID and the count value are read out from the ID storage 31 and the counter 33, respectively.

Then, the recorder 11 checks whether the read ID has been registered on the blacklist 61 or the whitelist 64 stored on the list storage 12 (S12). At that time, the recorder 11 checks whether an invalid ID 62 matched with the read ID has been registered on the blacklist 61 or whether a valid ID 65 matched with the read ID has been registered on the whitelist 64. When the read ID has been registered on the blacklist 61 (Y in S12, N in S18), the recorder 11 reads out, from the blacklist 61, an invalid count 63 corresponding to the invalid ID 62 matched with the read ID (S13).

When the count value read out from the IC card 3 is smaller than a value of the invalid count 63 (Y in S14), the recorder 11 calculates (the count value+1), i.e. performs counting-up, and stores the calculated value A on the counter 33 of the IC card 3 (S15). In other words, the recorder 11 updates the count value of the IC card 3 with the calculated value A. The recorder 11 may update the count value of the IC card 3 with the invalid count 63 instead of counting-up. Further, the recorder 11 stores validity information of “invalid” on the validity information storage 32 (S15).

Then, the recorder 11 creates a log including the ID read out from the IC card 3 and the calculated value A and transmits the created log to the log collecting module 26 of the server device 2 (S16). Lastly, the recorder 11 creates “a request for deletion from the blacklist” including the ID read out from the IC card 3 and transmits the created request to the deleting module 26 of the server device 2 (S17).

When the count value read out from the IC card 3 is not smaller than the value of the invalid count 63 (N in S14), the recorder 11 performs nothing.

When the ID read out from the IC card 3 has been registered on the whitelist 64 (Y in S12, Y in S18), the recorder 11 reads out, from the whitelist 64, an invalid count 63 corresponding to the valid ID 65 matched with the read ID (S19).

When the count value read out from the IC card 3 is equal to or smaller than the value of the invalid count 63 (Y in S1A), the recorder 11 stores validity information of “valid” on the validity information storage 32 (S1B). Lastly, the recorder 11 creates “a request for deletion from the whitelist” including the ID read out from the IC card 3 and transmits the created request to the deleting module 26 of the server device 2 (S1C).

When the count value read out from the IC card 3 is larger than the value of the invalid count 63 (N in S1A), the recorder 11 performs nothing.

Further, when the read ID has not been registered on either the blacklist 61 or the whitelist 64 stored on the list storage 12 (N in S12), the recorder 11 performs nothing.

When the IC card 3 returned to be valid from being invalid is assumed to be tapped to the reader/writer 15 before becoming invalid again, it is possible that the recorder 11 does not check, in S1A, whether the count value is equal to or smaller than the value of the invalid count 63 but checks whether the count value is equal to the value of the invalid count 63.

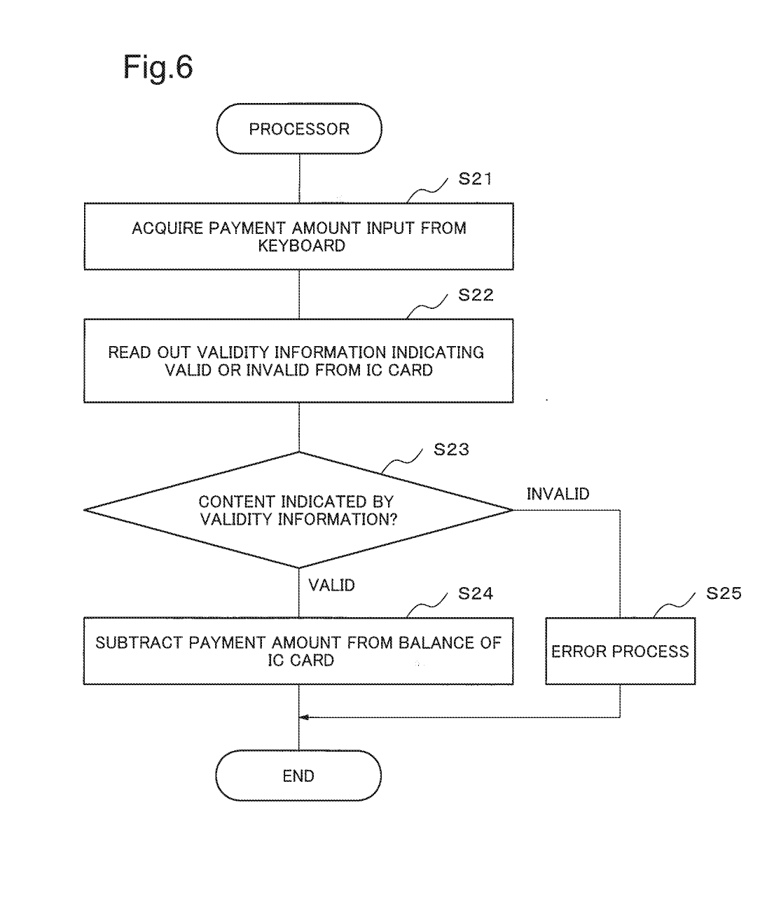

FIG. 6 is an operation flowchart of the processor 13. The processor 13 is started when, for example, the operation of the recorder 11 is terminated. The processor 13 executes a process for achieving an original purpose using an IC card 3, for example, a payment process using electronic money of the IC card 3.

The processor 13 initially acquires a payment amount input from a keyboard, not illustrated (S21), and then reads out validity information of valid or invalid from an IC card 3 (S22). The validity information is read out from the validity information storage 32.

When the validity information indicates “valid” (valid in S23), the processor 13 executes a payment process including subtraction of the payment amount from a balance of electronic money recorded on the balance storage 34 of the IC card 3 (S24). The payment process may include printing of a payment slip and transmission of payment data. When the validity information indicates “invalid” (invalid in S23), the processor 13 executes an error process (S25). At that time, the processor 13 outputs a warning message, for example, to a display device, not illustrated, of the terminal device 1.

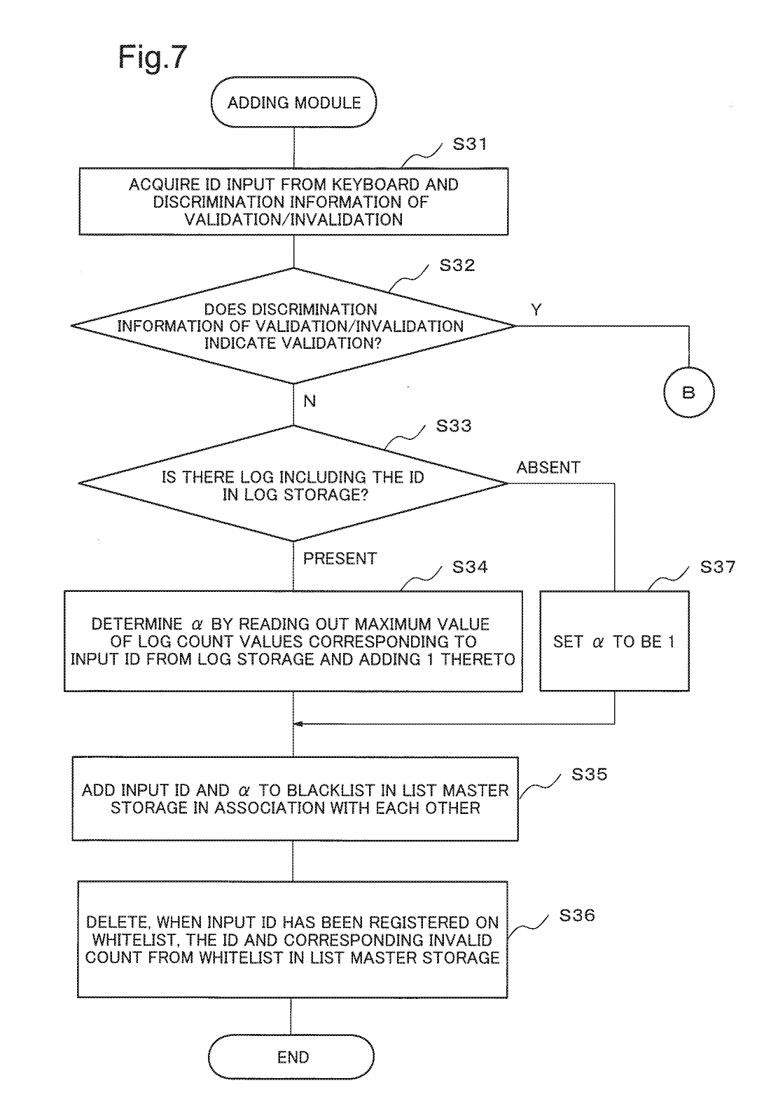

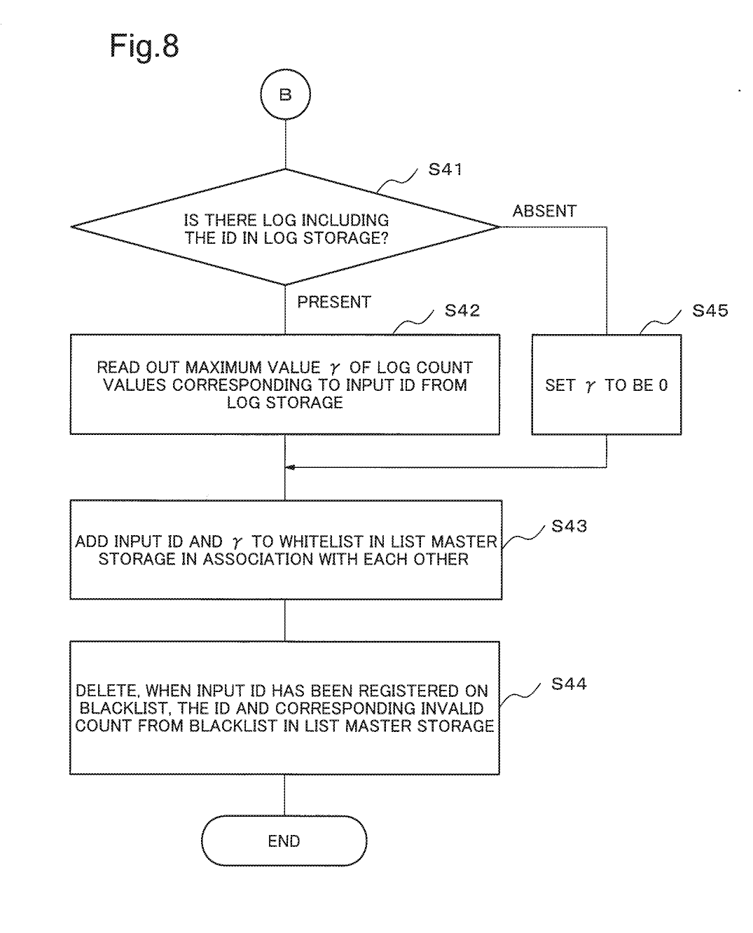

FIG. 7 and FIG. 8 each are an operation flowchart of the adding module 23 of the server device 2. The adding module 23 is started when an instruction for invalidation or validation of an IC card 3 is input from the keyboard 27 or the like.

Initially, the adding module 23 acquires an ID of an invalidated IC card 3 and discrimination information of validation/invalidation from the keyboard 27 (S31). Then, when the discrimination information indicates invalidation (N in S32), the adding module 23 checks whether a log of the log ID 51 matched with the ID has been stored on the log storage 21 (S33). When a certain IC card 3 has been repeatedly subjected to changes of invalid and valid at multiple times, there are a plurality of such logs. In the case the log has been stored (“present” in S33), the adding module 23 reads out a maximum log count value 52 among such one or more logs from the log storage 21 and determines a value α by adding 1 to the maximum log count value 52 (S34). The maximum log count value 52 is acquired from the latest log among logs of the log ID 51 matched with the input ID.

In the case the log has not been stored (“absent” in S33), the adding module 23 sets the value α to be 1 (S37).

Then, the adding module 23 associates the input ID with the value α and adds both thereof to the blacklist 61 in the list master storage 22 (S35). Specifically, the adding module 23 registers the input ID and the value α as an invalid ID 62 and an invalid count 63, respectively, on the blacklist 61.

Lastly, when the input ID has been registered on the whitelist 64, the adding module 23 deletes the ID and a corresponding invalid count from the whitelist 64 in the list master storage 22 (S36).

When the discrimination information of validation/invalidation indicates validation (Y in S32), the adding module 23 checks whether the log of the log ID 51 matched with the ID has been stored on the log storage 21 (S41). When a certain IC card 3 has been repeatedly subjected to changes of invalid and valid at multiple times, there are a plurality of such logs. In the case that the log has been stored (“present” in S41), the adding module 23 reads out a maximum log count value 52 among such one or more logs from the log storage 21 and acquires a value γ (S42). The maximum log count value 52 is acquired from the latest log among logs of the log ID 51 matched with the input ID.

In the case that the log has not been stored (“absent” in S41), the adding module 23 sets the value γ to be 0 (S45). The fact that the log of the log ID 51 matched with the input ID has not been stored on the log storage 21 means that the IC card 3 of the input ID has been brought to a store of a dealer or the like during a period of being invalidated and has not been tapped to the reader/writer 15, i.e. a count value of the IC card 3 is 0.

Then, the adding module 23 associates the input ID with the value γ and adds both thereof to the whitelist 64 in the list master storage 22 (S43). Specifically, the adding module 23 registers the input ID and the value γ as a valid ID 65 and an invalid count 63, respectively, on the whitelist 64.

Lastly, when the input ID has been registered on the blacklist 61, the adding module 23 deletes the ID and a corresponding invalid count from the blacklist 61 in the list master storage 22 (S44). The distributing module 25 distributes the blacklist 61 and the whitelist 64 in the list master storage 22 maintained/managed by the adding module 23 and the deleting module 24 to the terminal device 1. The distribution may be performed regularly or when addition or deletion has been performed at a certain number of times.

The validity control system 4 according to the present exemplary embodiment makes it easy to reuse an IC card 3 on which validity information indicating invalid has been written by being once invalidated. The reason is that the terminal device 1 stores the whitelist 64 including an ID of an IC card 3 once invalidated and then returned to be valid. The reason also includes that the terminal device 1 writes validity information indicating valid on the validity information storage 32 of the IC card 3 of the ID included in the whitelist 64.

A specific example will be described below. When, for example, a user of a credit card (IC card 3) has failed to pay a billed amount due to a shortage of a bank account balance, a credit company registers an ID of the IC card 3 of the user on the blacklist 61 using the adding module 23. Thereafter, when the user intends to perform payment at a certain store using the IC card 3, the terminal device 1 of the store writes validity information indicating invalid on the IC card 3 on the basis of the blacklist 61. Thereby, it becomes difficult for the user to perform the payment using the IC card 3.

However, when the user transmits an outstanding amount to the credit company, the credit company registers the ID of the IC card 3 of the user on the whitelist 64 using the adding module 23. In this state, when the user intends to perform payment at a certain store using the IC card 3, the terminal device 1 of the store writes validity information indicating valid on the IC card 3 on the basis of the whitelist 64. Thereby, the user can perform the payment using the IC card 3 again. In the case, the user need not visit any store of the credit company to resume and continue to use the IC card 3 once invalidated. Further, the user need not wait for a reissue of a credit card.

Further, the validity control system 4 according to the present exemplary embodiment can appropriately determine valid/invalid of a credit card, an IC card 3 storing electronic money, and the like on the basis of the whitelist 64. The system can appropriately determine valid/invalid also for an IC card 3 and the like once returned to be valid and then invalidated again. The reason is that an invalid count is stored on both the IC card 3 and the whitelist 64 stored by the terminal device 1.

When, for example, a certain IC card 3 has been invalidated for the first time and then validity information indicating invalid has been written on the validity information storage 32, and thereafter the card is returned to be valid, a count value of the counter 33 is 1. The invalid count 63 of the whitelist 64 of the first time is 1. Therefore, when the IC card 3 is input to the terminal device 1 that stores the whitelist 64 of the first time, the terminal device 1 records validity information of valid on the card. Thereafter, when the IC card 3 has been invalidated again and then validity information indicating invalid has been written again on the validity information storage 32, a count value of the counter 33 becomes 2. Therefore, thereafter, the IC card 3 is not determined to be valid by the terminal device 1 that stores the whitelist 64 of the first time, on the basis of the whitelist 64. In other words, when having been returned to be valid from being invalid and then returned to be invalid again, the IC card 3 is not erroneously determined to be valid, on the basis of the whitelist 64 that is old. Therefore, it is difficult for a user to tap the IC card 3 to the reader/writer 15 of the terminal device 1 and thereby to cause the processor 13 to execute a predetermined process, for example, a payment process using electronic money stored on the balance storage 34 or a credit balance of a credit card, on the basis of validity information indicating valid.

The IC card 3 may be changed to an IC memory of another shape or another recording medium, for example, a USB (Universal Serial Bus) memory. In this case, the reader/writer 15 is changed to a USB interface. Further, the IC card 3 may be replaced with a recording medium provided for the exterior of a car or a wheelchair and used, for example, for drive-through payment, instead of a subject carried by a person.

Further, a value stored on the invalid count 63 included in the counter 33 of the IC card 3, the whitelist 64, and the blacklist 61 need not always be a value of “a count” itself starting from an initial value 0 and being counted up one by one, as in the present exemplary embodiment. For example, as the value, information capable of identifying a count of invalid using a rule or a conversion table in the validity control system 4, i.e. an invalid count identifying value may be used. For example, a numerical value in which an initial value is 5 and is counted up by 2 at a time with an increase in a count of invalidation may be used.

Further, the invalid count identifying value may be a value in which an initial value is a large number to some extent, for example, 1000 and is counted down one by one with an increase in count. When an order is identified, the invalid count identifying value may be non-numerical information, for example, an alphabet or kana character.

In such a case, the comparison of S14 of FIG. 4, the description of counting-up of S15, and the comparison of S1A of FIG. 5 performed by the recorder 11 mean description of processing upon mapping the invalid count identifying value as a count. Calculation actually performed for an invalid count identifying value is slightly changed in accordance with the invalid count identifying value. When, for example, the invalid count identifying value is a numerical value counted down one by one with an increase in count, a magnitude relation of the determination of S14 and S1A becomes reversed. Further, the processing for increasing a count of invalid by 1 in S15 becomes processing for counting down the invalid count identifying value by 1. Hereinafter, calculation (counting-down by 1 in the above example) for an invalid count identifying value equivalent to processing for increasing a count by 1 is expressed, in some cases, in such a manner that “an invalid count identifying value is advanced.”

It is possible that the terminal device 1 does not include the processor 13 and another device includes the processor 13. It is possible that the recorder 11 and the processor 13 are integrally mounted and, for example, the recorder 11 includes a function of the processor 13.

It is possible that the recorder 11 does not transmit “a request for deletion from the blacklist” (S17) or “a request for deletion from the whitelist” (S1C). In this case, for example, an administrator of the validity control system 4 deletes a processed ID from the blacklist 61 and the whitelist 64, as appropriate. At that time, the server device 2 need not include the deleting module 24.

Further, the log storage 21 is referred to also as an invalid count storage 2A, and the counter 33 is referred to also as a setting value storage 35.

The variations illustrated for the present exemplary embodiment are also applicable to the following exemplary embodiments.

### Second Exemplary Embodiment

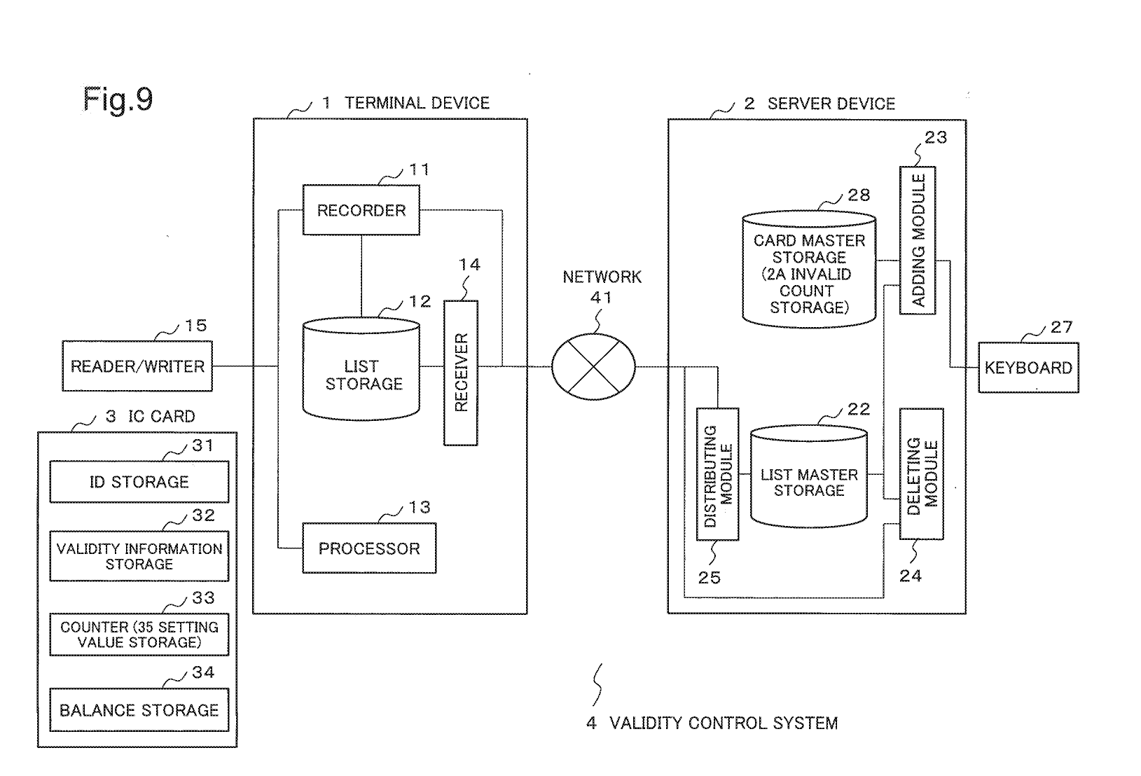

FIG. 9 is a configuration diagram of a validity control system 4 according to a second exemplary embodiment. The validity control system 4 according to the present exemplary embodiment does not include the log collecting module 26 or the log storage 21 included in the validity control system 4 according to the first exemplary embodiment but instead thereof, includes a card master storage 28.

The card master storage 28 is a storage device such as an IC memory, a disk device, or the like.

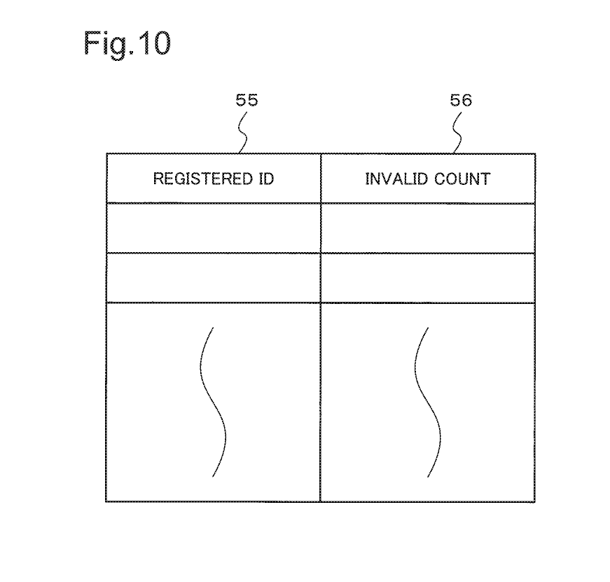

FIG. 10 illustrates a configuration of data stored on the card master storage 28 of the server device 2. The card master storage 28 stores registered IDs 55 that are IDs of, for example, all the issued IC cards 3 that are able to be invalidated and invalid counts 56 that are counts in which the IC cards 3 have been invalidated. For example, a bank or a credit card company registers a registered ID 55 and an initial value 0 of the invalid count 56 on the card master storage 28 each time issuing an IC card 3 to a user.

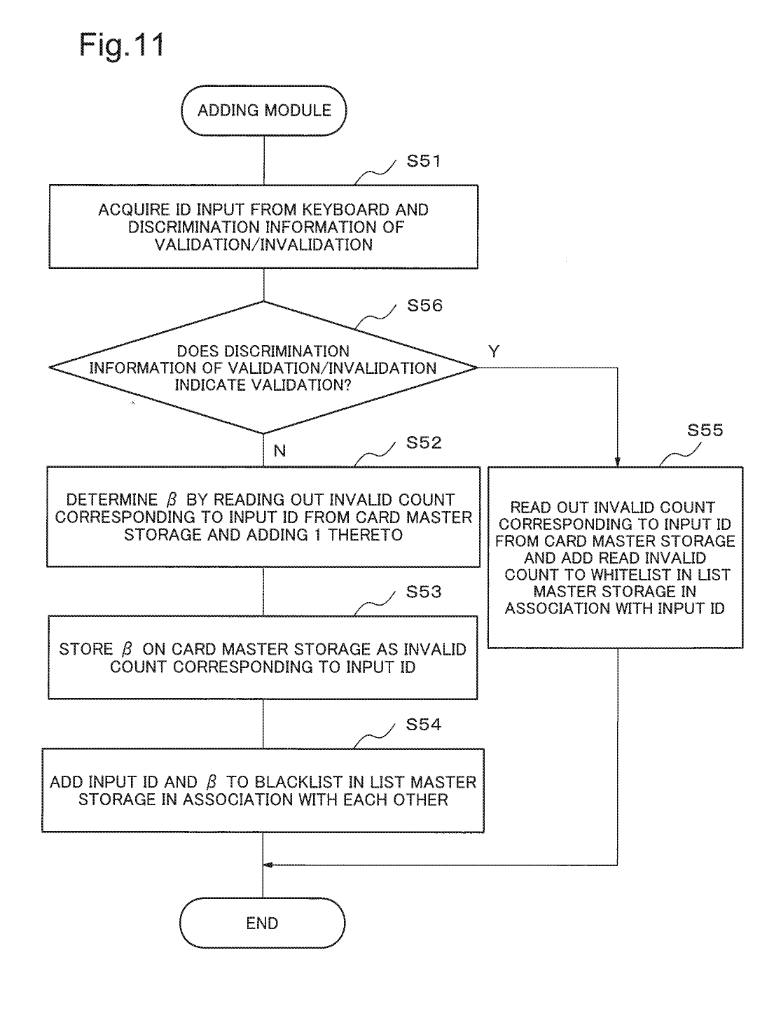

FIG. 11 is an operation flowchart of the adding module 23 according to the present exemplary embodiment. The adding module 23 is started when an instruction for invalidation or validation of an IC card 3 is input from the keyboard 27 or the like.

Initially, the adding module 23 acquires an ID of an invalidated IC card 3 and discrimination information of validation/invalidation from the keyboard 27 (S51). Then, when an instruction for invalidation is input (N in S56), the adding module 23 reads out an invalid count 56 corresponding to a registered ID 55 matched with the ID acquired from the keyboard 27 from the card master storage 28 and determines a value β by adding 1 to the invalid count 56 (S52).

The adding module 23 stores the value β as an invalid count 56 corresponding to the registered ID 55 matched with the ID acquired from the keyboard 27 on the card master storage 28 (S53).

Lastly, the adding module 23 associates the ID acquired from the keyboard 27 with the value β and adds both thereof to the blacklist 61 in the list master storage 22 (S54). Specifically, the adding module 23 registers the ID acquired from the keyboard 27 and the value β as an invalid ID 62 and an invalid count 63, respectively, on the blacklist 61.

When an instruction for validation is input (Y in S56), the adding module 23 reads out an invalid count 56 corresponding to the registered ID 55 matched with the ID acquired from the keyboard 27 from the card master storage 28, associates the read value with the ID acquired from the keyboard 27, and adds both thereof to the whitelist 64 in the list master storage 22 (S55). Specifically, the adding module 23 registers the ID acquired from the keyboard 27 and the read invalid count 56 as a valid ID 65 and an invalid count 63, respectively, on the whitelist 64.

The recorder 11 according to the present exemplary embodiment does not perform transmission of a log (S16 of FIG. 4). Further, the validity control system 4 according to the present exemplary embodiment is the same as the validity control system 4 according to the first exemplary embodiment except those described above.

The validity control system 4 according to the present exemplary embodiment produces the same effect as the validity control system 4 according to the first exemplary embodiment with suppressing a load of the network 41. The reason is that the terminal device 1 transmits no log to the server device 2.

The card master storage 28 is referred to also as an invalid count storage 2A.

### Third Exemplary Embodiment

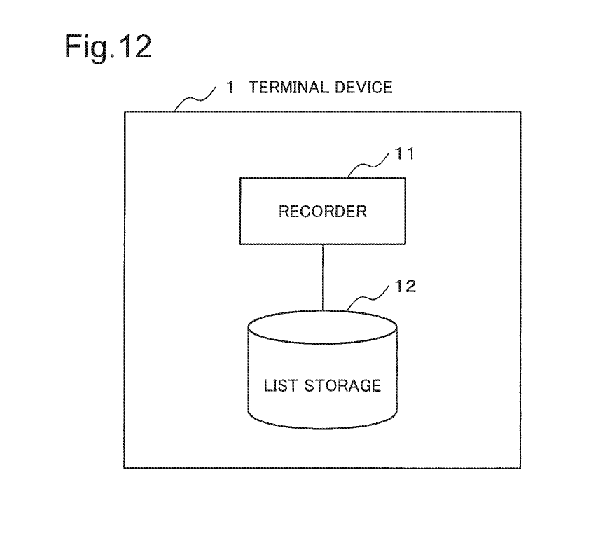

FIG. 12 is a configuration diagram of a terminal device 1 according to a third exemplary embodiment. The terminal device 1 includes the recorder 11 and the list storage 12.

The list storage 12 stores a whitelist 64 associating an invalid count 63 of an IC card 3 that stores an ID, validity information indicating valid or invalid, and a count value with a valid ID 65 that is an ID returned to be valid from being invalid.

The recorder 11 reads out, from the whitelist 64, an invalid count 63 corresponding to an ID read out from an IC card 3 and compares the read invalid count with a count value read out from the IC card 3. As the comparison result, when the count value is equal to the invalid count, the recorder 11 executes a validation process that stores validity information indicating valid on the IC card 3 and a predetermined process, for example, a payment process.

The terminal device 1 according to the present exemplary embodiment makes it easy to reuse an IC card 3 on which validity information indicating invalid has been written by being once invalidated. The reason is the same as described in the first exemplary embodiment.

### Fourth Exemplary Embodiment

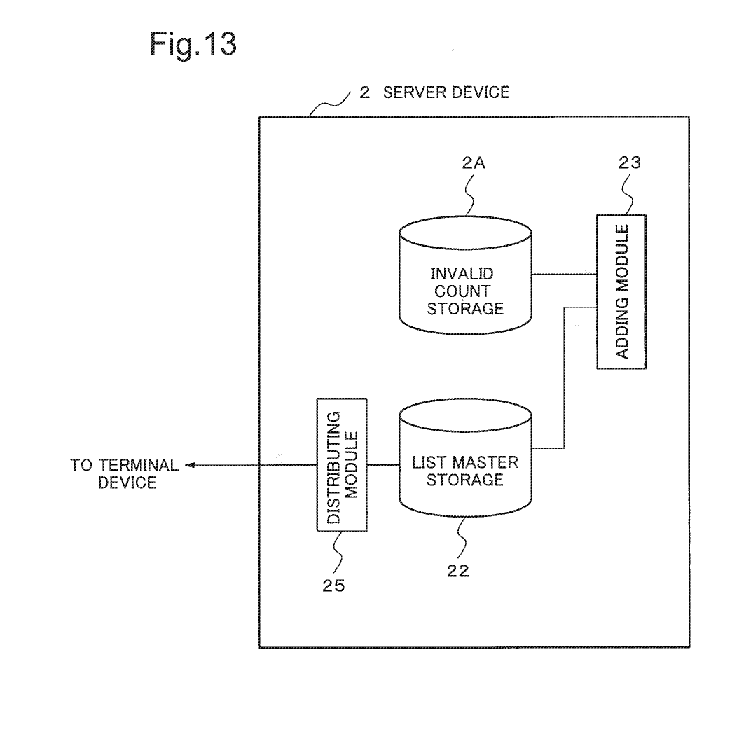

FIG. 13 is a configuration diagram of a server device 2 according to a fourth exemplary embodiment.

The server device 2 is connected to a terminal device. The terminal device reads out, from a whitelist stored in the terminal device, an invalid count corresponding to an ID read out from an IC card, and compares the read invalid count with a setting value read out from the IC card. As the comparison result, when the setting value is equal to the invalid count identifying value, the terminal device executes a validation process that stores validity information indicating valid on the IC card 3 and a predetermined process, for example, a payment process.

Further, the server device 2 includes the invalid count storage 2A, the list master storage 22, the adding module 23, and the distributing module 25.

The invalid count storage 2A stores an invalid count in association with an ID of an invalidated IC card 3. The list master storage 22 stores originals of a whitelist 64 and a blacklist 61 associating an invalid count 63 and an invalid ID 62 of an IC card 3.

The adding module 23 counts up, when an ID of an invalidated IC card 3 is input, an invalid count stored on the invalid count storage 2A in association with the input ID and adds the counted-up value to the original of the blacklist 61 as an invalid count 63 corresponding to the input ID. Further, the adding module 23 adds, when the ID of the IC card 3 returned to be valid is input, the invalid count 63 corresponding to the input ID to the original of the whitelist 64. The distributing module 25 distributes the original of the whitelist 64 to the terminal device.

The terminal device connected to the server device 2 according to the present exemplary embodiment makes it easy to reuse an IC card 3 on which validity information indicating invalid has been written by being once invalidated. The reason is the same as described in the first exemplary embodiment.

The whole or part of the exemplary embodiments disclosed above can be described as, but not limited to, the following supplementary notes.

(Supplementary Note 1)

A terminal device including:

a list storage means for storing a whitelist associating an invalid count identifying value of a recording medium that stores an identifier, validity information indicating valid or invalid, and a setting value with the identifier; and

a recording means for reading out, from the whitelist, the invalid count identifying value corresponding to the identifier read out from the recording medium, comparing the invalid count identifying value with the setting value read out from the recording medium, and executing a validation process that stores the validity information indicating valid on the recording medium and a predetermined process when the setting value is equal to the invalid count identifying value.

(Supplementary Note 2)

The terminal device according to supplementary note 1, wherein the recording means executes the predetermined process based on the validity information of the recording medium without executing the validation process when the setting value is not equal to the invalid count identifying value.

(Supplementary Note 3)

The terminal device according to supplementary note 2, wherein

the list storage means further includes a blacklist associating the invalid count identifying value of the recording medium with the identifier, and

the recording means reads out, from the blacklist, the invalid count identifying value corresponding to the identifier read out from the recording medium, compares the invalid count identifying value with the setting value read out from the recording medium, updates the setting value stored on the recording medium with the invalid count identifying value when the setting value is smaller than the invalid count identifying value, and executes an invalidation process that stores the validity information indicating invalid on the recording medium, or alternatively, reads out, from the whitelist, the invalid count identifying value corresponding to the identifier read out from the recording medium, compares the invalid count identifying value with the setting value read out from the recording medium, and executes the predetermined process based on the validity information of the recording medium without executing the validation process when the setting value is larger than the invalid count identifying value.

(Supplementary Note 4)

The terminal device according to supplementary note 3, wherein

the terminal device is connected to a server device that acquires the identifier of the recording medium invalidated, adds the identifier and the invalid count identifying value to an original of the blacklist in association with each other, acquires the identifier of the recording medium validated, adds the identifier and the invalid count identifying value to an original of the whitelist in association with each other, and distributes the originals of the blacklist and the whitelist, and

further including a receiving means for receiving the blacklist and the whitelist distributed from the server device and storing the received blacklist and the received whitelist on the list storage means.

(Supplementary Note 5)

The terminal device according to any one of supplementary notes 1 to 4, wherein the recording means executes the predetermined process upon being valid and does not execute the predetermined process upon being invalid based on the validity information read out from the recording medium.

(Supplementary Note 6)

A validity control system including:

the server device; and

the terminal device according to supplementary note 4 or 5.

(Supplementary Note 7)

A recording medium including:

an ID storage that stores an identifier read out from a terminal device that reads out, from a whitelist stored in the terminal device, an invalid count identifying value corresponding to the identifier read out from the recording medium, compares the invalid count identifying value with a setting value read out from the recording medium, and executes a validation process that stores the validity information indicating valid on the recording medium and a predetermined process when the setting value is equal to the invalid count identifying value;

a validity information storage that stores the validity information; and

a setting value storage that stores the setting value.

(Supplementary Note 8)

A server device connected to a terminal device that reads out, from a whitelist stored in the terminal device, an invalid count identifying value corresponding to an identifier read out from a recording medium, compares the invalid count identifying value with a setting value read out from the recording medium, and executes a validation process that stores the validity information indicating valid on the recording medium and a predetermined process when the setting value is equal to the invalid count identifying value, including:

an invalid count storage means for storing the invalid count identifying value in association with the identifier of the recording medium invalidated;

a list master storage means for storing an original of the whitelist and an original of a blacklist associating the invalid count identifying value of the recording medium with the identifier;

an adding means for advancing, when the identifier of the recording medium invalidated is input, the invalid count identifying value stored on the invalid count storage means in association with the input identifier, adding the advanced value to the original of the blacklist as the invalid count identifying value corresponding to the input identifier, and adding, when the identifier of the recording medium returned to be valid is input, the invalid count identifying value corresponding to the input identifier to the original of the whitelist; and a list distributing means for distributing the original of the whitelist to the terminal device.

(Supplementary Note 9)

The server device according to supplementary note 8, wherein

the server device is connected to the terminal device that, when the setting value is not equal to the invalid count identifying value, updates the setting value stored on the recording medium with the invalid count identifying value, executes a recording process that invalidates the validity information, and transmits a log including the identifier and the updated setting value in the recording process, and

further including a log collecting means for receiving the log and accumulates the log on the invalid count storage means, wherein

the adding means is subjected to an input of the identifier of the recording medium invalidated, advances a maximum value among the setting values stored on the invalid count storage means in association with the input identifier, and adds the advanced value to the original of the blacklist as the invalid count identifying value corresponding to the input identifier.

(Supplementary Note 10)

The server device according to supplementary note 8, wherein

the invalid count storage means stores the identifier and the invalid count identifying value of the recording medium to be invalidated in association with each other, and

the adding means is subjected to an input of the identifier of the recording medium invalidated, advances the invalid count identifying value stored on the invalid count storage means in association with the input identifier, and adds the advanced value to the original of the blacklist as the invalid count identifying value corresponding to the input identifier.

(Supplementary Note 11)

A method including:

storing a whitelist associating an invalid count identifying value of a recording medium that stores an identifier, validity information indicating valid or invalid, and a setting value with the identifier; and

reading out, from the whitelist, the invalid count identifying value corresponding to the identifier read out from the recording medium, comparing the invalid count identifying value with the setting value read out from the recording medium, and executing a validation process that stores the validity information indicating valid on the recording medium and a predetermined process when the setting value is equal to the invalid count identifying value.

(Supplementary Note 12)

The method according to supplementary note 11, further including executing the predetermined process based on the validity information of the recording medium without executing the validation process when the setting value is not equal to the invalid count identifying value.

(Supplementary Note 13)

The method according to supplementary note 12, further including:

storing a blacklist associating the invalid count identifying value of the recording medium with the identifier, and

reading out, from the blacklist, the invalid count identifying value corresponding to the identifier read out from the recording medium, comparing the invalid count identifying value with the setting value read out from the recording medium, updating the setting value stored on the recording medium with the invalid count identifying value when the setting value is smaller than the invalid count identifying value, and executing an invalidation process that stores the validity information indicating invalid on the recording medium, or alternatively, reading out, from the whitelist, the invalid count identifying value corresponding to the identifier read out from the recording medium, comparing the invalid count identifying value with the setting value read out from the recording medium, and executing the predetermined process based on the validity information of the recording medium without executing the validation process when the setting value is larger than the invalid count identifying value.

(Supplementary Note 14)

The method according to supplementary note 13, further including:

receiving the blacklist and the whitelist distributed from a server device that acquires the identifier of the recording medium invalidated, adds the identifier and the invalid count identifying value to an original of the blacklist in association with each other, acquires the identifier of the recording medium validated, adds the identifier and the invalid count identifying value to an original of the whitelist in association with each other, and distributes the originals of the blacklist and the whitelist; and

storing the received blacklist and the received whitelist.

(Supplementary Note 15)

The method according to any one of supplementary notes 11 to 14, further including executing the predetermined process upon being valid and not executing the predetermined process upon being invalid based on the validity information read out from the recording medium.

(Supplementary Note 16)

A method including:

connecting to a terminal device that reads out, from a whitelist stored in the terminal device, an invalid count identifying value corresponding to an identifier read out from a recording medium, compares the invalid count identifying value with a setting value read out from the recording medium, and executes a validation process that stores the validity information indicating valid on the recording medium and a predetermined process when the setting value is equal to the invalid count identifying value;

storing the invalid count identifying value in association with the identifier of the recording medium invalidated, in an invalid count storage means;

storing an original of the whitelist and an original of a blacklist associating the invalid count identifying value of the recording medium with the identifier;

advancing, when the identifier of the recording medium invalidated is input, the invalid count identifying value stored on the invalid count storage means in association with the input identifier, adding the advanced value to the original of the blacklist as the invalid count identifying value corresponding to the input identifier, and adding, when the identifier of the recording medium returned to be valid is input, the invalid count identifying value corresponding to the input identifier to the original of the whitelist; and

distributing the original of the whitelist to the terminal device.

(Supplementary Note 17)

The method according to supplementary note 16, further including:

connecting to the terminal device that, when the setting value is not equal to the invalid count identifying value, updates the setting value stored on the recording medium with the invalid count identifying value, executes a recording process that invalidates the validity information, and transmits a log including the identifier and the updated setting value in the recording process,

receiving the log and accumulating the log on the invalid count storage means, and

inputting the identifier of the recording medium invalidated, advancing a maximum value among the setting values stored on the invalid count storage means in association with the input identifier, and adding the advanced value to the original of the blacklist as the invalid count identifying value corresponding to the input identifier.

(Supplementary Note 18)

The method according to supplementary note 16, further including:

storing the identifier and the invalid count identifying value of the recording medium to be invalidated in association with each other, and

inputting the identifier of the recording medium invalidated, advancing the invalid count identifying value stored on the invalid count storage means in association with the input identifier, and adding the advanced value to the original of the blacklist as the invalid count identifying value corresponding to the input identifier.

(Supplementary Note 19)

A computer readable storage medium recording thereon a program, causing a computer to perform the method according to any one of supplementary notes 11 to 18.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese Patent Application No. 2013-190156, filed on Sep. 13, 2013, the disclosure of which is incorporated herein in its entirety by reference.

### REFERENCE SIGNS LIST

1 Terminal device
2 Server device
3 IC card
4 Validity control system
11 Recorder
12 List storage
13 Processor
14 Receiver
15 Reader/writer
21 Log storage
22 List master storage
23 Adding module
24 Deleting module
25 Distributing module
26 Log collecting module
27 Keyboard
28 Card master storage
2A Invalid count storage
31 ID storage
32 Validity information storage
33 Counter
34 Balance storage
35 Setting value storage
41 Network
51 Log ID
52 Log count value
55 Registered ID
56, 63 Invalid count
61 Blacklist
62 Invalid ID
64 Whitelist
65 Valid ID

What is claimed is:

1.-13. (canceled)

14. A terminal device comprising:
a storage which stores a list of identifiers and counts for each identifier;
a processor which reads an identifier and a setting count from a recording medium, and updates at least a validity information or the setting count on the recording medium based on the count associated with the identifier on the list.

15. The terminal device according to claim 14, wherein
the storage stores, as the list, a whitelist associating the count of the recording medium with the identifier, and
the processor reads out, from the whitelist, the count corresponding to the identifier read out from the recording medium and stores information indicating valid on the recording medium when the count is equal to the setting count read out from the recording medium.

16. The terminal device according to claim 15, wherein
the storage further stores, as the list, a blacklist associating the count of the recording medium with the identifier, and
the processor reads out, from the blacklist, the count corresponding to the identifier read out from the recording medium, compares the count with the setting count read out from the recording medium, updates the setting count stored on the recording medium with the count when the setting count is smaller than the count, and stores the validity information indicating invalid on the recording medium.

17. The terminal device according to claim 16, wherein
the terminal device is connected to a server device that acquires the identifier of the recording medium invalidated, adds the identifier and the count to an original of the blacklist in association with each other, acquires the identifier of the recording medium validated, adds the identifier and the count to an original of the whitelist in association with each other, and distributes the originals of the blacklist and the whitelist, and
further comprising a receiver which receives the blacklist and the whitelist distributed from the server device and stores the received blacklist and the received whitelist on the storage.

18. The terminal device according to claim 14, wherein the processor executes the predetermined process upon being valid and does not execute the predetermined process upon being invalid based on the validity information read out from the recording medium.

19. A server device comprising:
a count storage which stores a count in association with an identifier of a recording medium invalidated;
a list master storage which stores an original of a whitelist and an original of a blacklist associating the count of the recording medium with the identifier;
at least one processor which advances, when the identifier of the recording medium invalidated is input, the count stored on the count storage in association with the input identifier, adds the advanced value to the original of the blacklist as the count corresponding to the input identifier, adds, when the identifier of the recording medium returned to be valid is input, the count corresponding to the input identifier to the original of the whitelist; and distributes the original of the whitelist to a terminal device which reads out, from the whitelist stored in the terminal device, the count corresponding to the identifier read out from the recording medium, compares the count with a setting count read out from the recording medium, and executes a validation process that stores validity information indicating valid on the recording medium and a predetermined process when the setting count is equal to the count.

20. A method comprising:
storing a list of identifiers and counts for each identifier;
reading an identifier and a setting count from a recording medium; and
updating at least a validity information or the setting count on the recording medium based on the count associated with the identifier on the list.

21. The method according to claim 20, wherein
the storing stores, as the list, a whitelist associating the count of the recording medium with the identifier,
the reading reads out, from the whitelist, the count corresponding to the identifier read out from the recording medium, and
the updating stores information indicating valid on the recording medium when the count is equal to the setting count read out from the recording medium.

22. The method according to claim 21,
the storing further stores, as the list, a blacklist associating the count of the recording medium with the identifier,
the reading reads out, from the blacklist, the count corresponding to the identifier read out from the recording medium, and
the updating compares the count with the setting count read out from the recording medium, updates the setting count stored on the recording medium with the count when the setting count is smaller than the count, and stores the validity information indicating invalid on the recording medium.

23. The method according to claim 22, further comprising:
receiving the blacklist and the whitelist distributed from a server device that acquires the identifier of the recording medium invalidated, adds the identifier and the count to an original of the blacklist in association with each other, acquires the identifier of the recording medium validated, adds the identifier and the count to an original of the whitelist in association with each other, and distributes the originals of the blacklist and the whitelist; and
storing the received blacklist and the received whitelist.

24. The method according to claim 20, further comprising executing the predetermined process upon being valid and not executing the predetermined process upon being invalid based on the validity information read out from the recording medium.

25. A method comprising:
storing a count in association with an identifier of a recording medium invalidated;
storing an original of a whitelist and an original of a blacklist associating the count of the recording medium with the identifier;
advancing, when the identifier of the recording medium invalidated is input, the count stored in association with the input identifier;
adding the advanced value to the original of the blacklist as the count corresponding to the input identifier;
adding, when the identifier of the recording medium returned to be valid is input, the count corresponding to the input identifier to the original of the whitelist; and
distributing the original of the whitelist to a terminal device which reads out, from the whitelist stored in the terminal device, the count corresponding to the identifier read out from the recording medium, compares the count with a setting count read out from the recording medium, and executes a validation process that stores validity information indicating valid on the recording medium and a predetermined process when the setting count is equal to the count.

26. A non-transitory computer readable storage medium recording thereon a program, causing a computer to perform the method according to claim 20.

27. A terminal device comprising:
a storage means for storing a list of identifiers and counts for each identifier;
a processing means for reading an identifier and a setting count from a recording medium, and updating at least a validity information or the setting count on the recording medium based on the count associated with the identifier on the list.

28. A server device comprising:
a count storage means for storing a count in association with an identifier of a recording medium invalidated;
a list master storage means for storing an original of a whitelist and an original of a blacklist associating the count of the recording medium with the identifier;
at least one processing means for advancing, when the identifier of the recording medium invalidated is input, the count stored on the count storage means in association with the input identifier, adding the advanced value to the original of the blacklist as the count corresponding to the input identifier, adding, when the identifier of the recording medium returned to be valid is input, the count corresponding to the input identifier to the original of the whitelist; and distributing the original of the whitelist to a terminal device which reads out, from the whitelist stored in the terminal device, the count corresponding to the identifier read out from the recording medium, compares the count with a setting count read out from the recording medium, and executes a validation process that stores validity information indicating valid on the recording medium and a predetermined process when the setting count is equal to the count.
